(19) United States
(12) Patent Application Publication
(10) Pub. No.: US 2002/0059118 A1
(43) Pub. Date: May 16, 2002

(54) Method and system for ordering sales items

(75) Inventor: Hajime Ashihara, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC INFRONTIA CORPORATION

(21) Appl. No.: 09/986,554

(22) Filed: Nov. 9, 2001

(30) Foreign Application Priority Data
Nov. 10, 2000 (JP) 2000-343151

(51) Int. Cl. G06F 17/60

(52) U.S. Cl. 705/27

(57) ABSTRACT

For ordering a sales item, sales information is sent from an agent server to a user terminal via a communications network. The sales information contains items that are only available in shops which are not accessible via the communications network. At the user terminal the transmitted sales information is displayed, allowing a user to select an item. When the order button is clicked, a purchase order of the selected item is sent from the user terminal to the agent server for requesting a purchase of the selected item on behalf of the user. In response, the agent server transmits an acknowledgment message to the user terminal. In addition, the user can place an order for inspection of the selected item if he desires further details of the item, or a search service if the desired item is not contained in the sales information.

### BACKGROUND OF THE INVENTION

1. Field of the Invention

The present invention relates to a method and system for ordering system for placing an order for sales items via a communications network. The present invention is particularly useful for purchasing items available only in shops not connected to the network.

2. Description of the Related Art

Placing an electronic order for a sales item through a communications network such as the Internet has met with success and gained a wide acceptance. However, there are still many sales shops that are not connected to the network. For ordering items that are only available in such non-networked shops, the customer has the trouble of making a trip to a target shop or continuing the trip for a search if the desired item is not available. In addition, with the current ordering system the customer has to be content with sales information supplied from the network to make a decision on whether or not to place an order. As a result, a situation can occur where the customer is not satisfied with a purchased item when it is different from what the customer originally imagined. Further, if the sales information sent from the network contains no desired item, the customer makes a trip around shopping areas in search of the product. This is particularly disadvantages for customers living in remote areas from shopping areas.

### SUMMARY OF THE INVENTION

It is therefore an object of the present invention to provide a method and system for ordering items through a communications network, wherein the items are only available in sales shops that are inaccessible via the communications network.

Another object of the present invention is to provide a method and system for ordering items which meet with customers' satisfaction.

According to a first aspect of the present invention, there is provided an ordering method comprising the steps of transmitting sales information, or catalogue from an agent server to a user terminal via a communications network. The sales information contains sales items that are only available in sales shops which are not accessible via the communications network. At the user terminal the transmitted sales information is displayed, allowing a user to select an item. A purchase order of the selected item is sent from the user terminal to the agent server for requesting a purchase of the selected item on behalf of the user. In response to the purchase order, the agent server transmits an acknowledgment message to the user terminal.

According to a second aspect, the present invention provides an ordering method comprising transmitting sales information from an agent server to a user terminal via a communications network. The user terminal displays the transmitted sales information allowing a user to select an item and transmits a request signal to the server for a service charge required for inspecting the selected item. The agent server determines the service charge depending on contents of the request signal and a cost database, and transmits the determined service charge to the user terminal. The user terminal displays the transmitted service charge to allow the user to make a decision as to whether an inspection of the selected item is performed and transmits a request signal to the server for indicating that the selected item be inspected when the user makes the decision. The agent server transmits an inspection report of the item to the user terminal, which displays the transmitted inspection report to allow the user to make a decision as to whether the item is purchased and transmits a purchase order to the agent server for requesting a purchase of the selected item on behalf of the user when the user makes the decision. The agent server transmits an acknowledgment message to the user terminal in response to the purchase order.

According to a third aspect, the present invention provides an ordering method comprising transmitting sales information from an agent server to a user terminal via a communications network. At the user terminal, the transmitted sales information is displayed, allowing a user to select an item and a request signal is sent to the server for a service charge required for making a search for a desired item if the desired item is not found in the displayed information. The agent server determines the service charge depending on contents of the request signal and a cost database, and transmits the determined service charge to the user terminal. The user terminal displays the transmitted service charge to allow the user to make a decision as to whether the search is performed and transmitting a request signal to the server for indicating that the desired item be searched when the user makes the decision. In response, the agent prepares a search report of the selected item. The search reports is transmitted from the agent server to the user terminal, where it is displayed to allow the user to make a decision as to whether the item is purchased. When the user makes the decision, a purchase order is sent from the user terminal to the agent server for requesting a purchase of the item on behalf of the user. The agent server transmits an acknowledgment message to the user terminal in response to the purchase order.

According to a fourth aspect, the present invention provides an ordering method comprising the steps of (a) transmitting sales information from an agent server to a user terminal via a communications network, (b) at the user terminal, displaying the transmitted sales information to allow a user to select one of a plurality of decision branches, (c) transmitting to the agent server a purchase order if the user selects a first decision branch, a first request signal for requesting a first service charge required for inspecting a desired item contained in the displayed information if the user selects a second decision branch, and a second request signal for requesting a second service charge required for making a search of a desired item which is not contained in the displayed information if the user selects a third decision branch, (d) at the agent server, determining the first service charge if the first request signal is received depending on contents of the first request signal and a cost database, determining the second service charge if the second request signal is received depending on contents of the second request signal and a cost database, and transmitting the determined first or second service charge to the user terminal, (e) at the user terminal, displaying the transmitted service charge to allow the user to make a decision as to whether an inspection or a search of the desired item is performed and transmitting a request signal to the server for indicating that the desired item be inspected or searched when the user makes the decision, (f) at the agent server, transmitting an inspection report of the item or a search report of the item to the user terminal, depending on contents of the request signal of step (e), (g) at the user terminal, displaying the transmitted inspection report or search report to allow the user to make a decision as to whether the item is purchased and transmitting a purchase order to the agent server for requesting a purchase of the item on behalf of the user if the user makes the decision, and (h) at the agent server, transmitting an acknowledgment message to the user terminal if the purchase order of step (c) or step (g) is received.

### BRIEF DESCRIPTION OF THE DRAWIGNS

The present invention will be described in detail further with reference to the following drawings, in which:

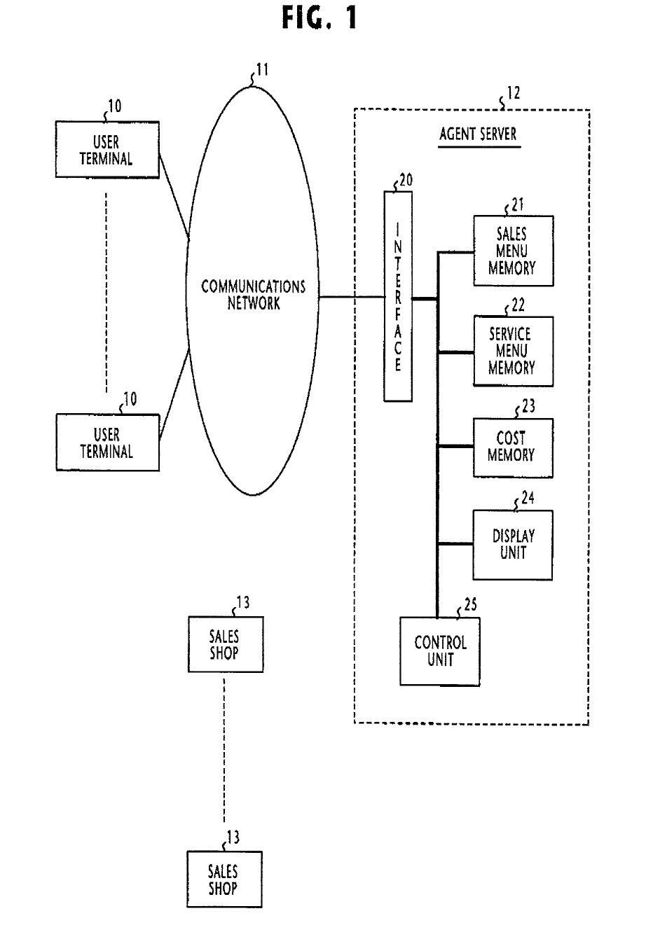

FIG. 1 is a block diagram of a communications network for receiving purchase orders for purchasing sales items on behalf of customers;

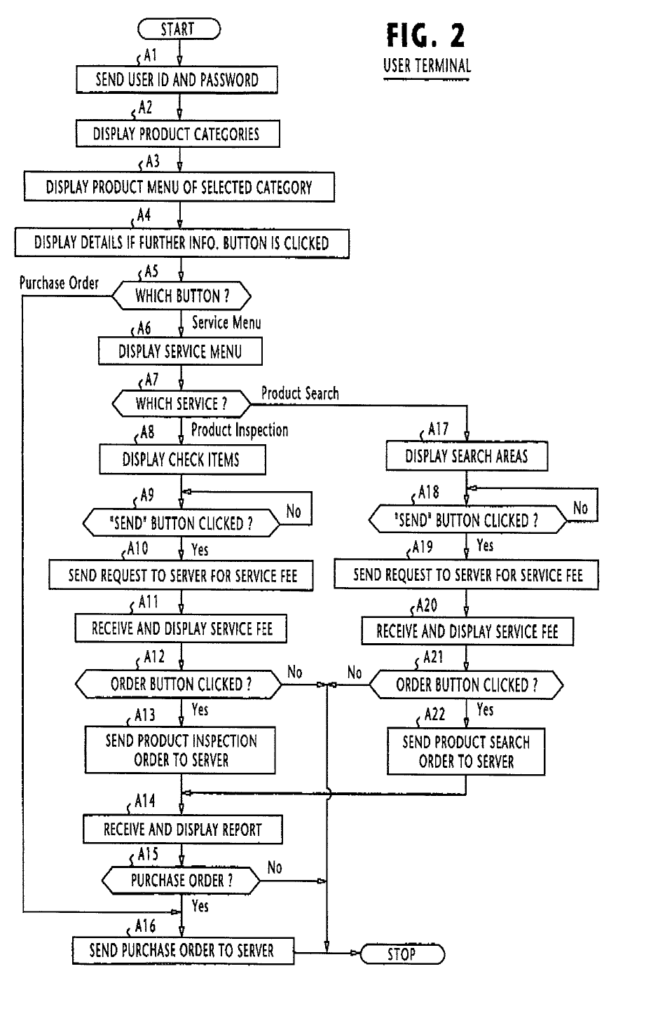

FIG. 2 is a flowchart of the operation of a user terminal of the present invention;

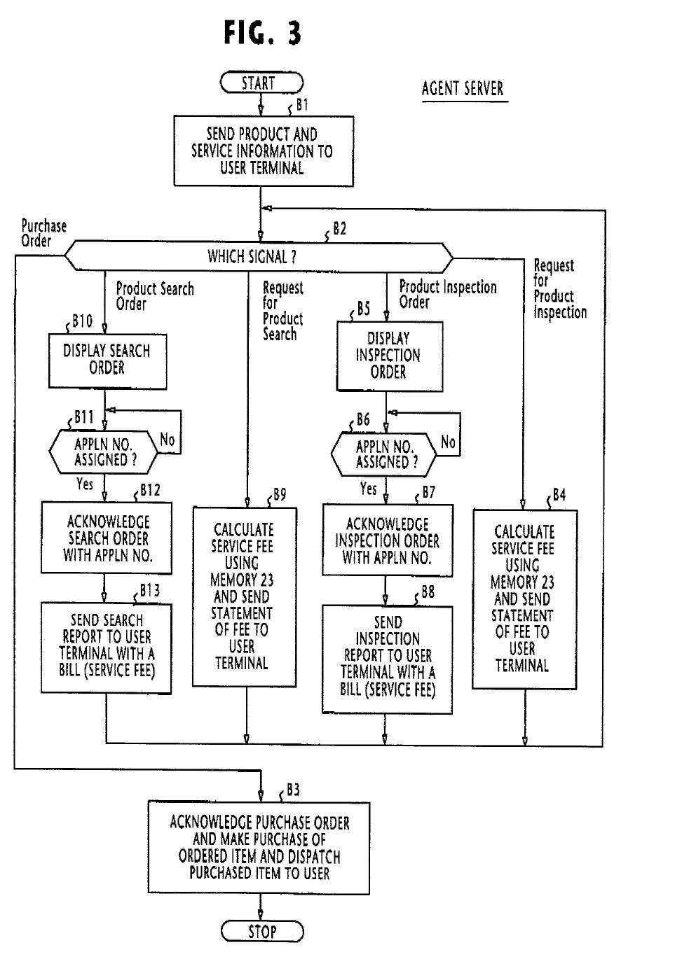

FIG. 3 is a flowchart of the operation of an agent server of the present invention;

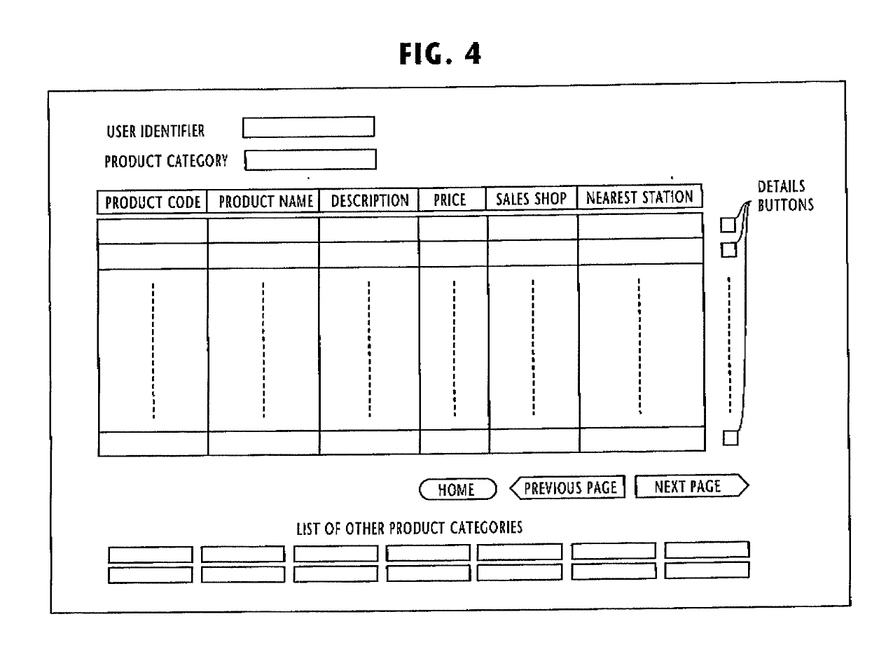

FIG. 4 is an illustration of a window displayed on the user terminal when sales information is received from the agent server;

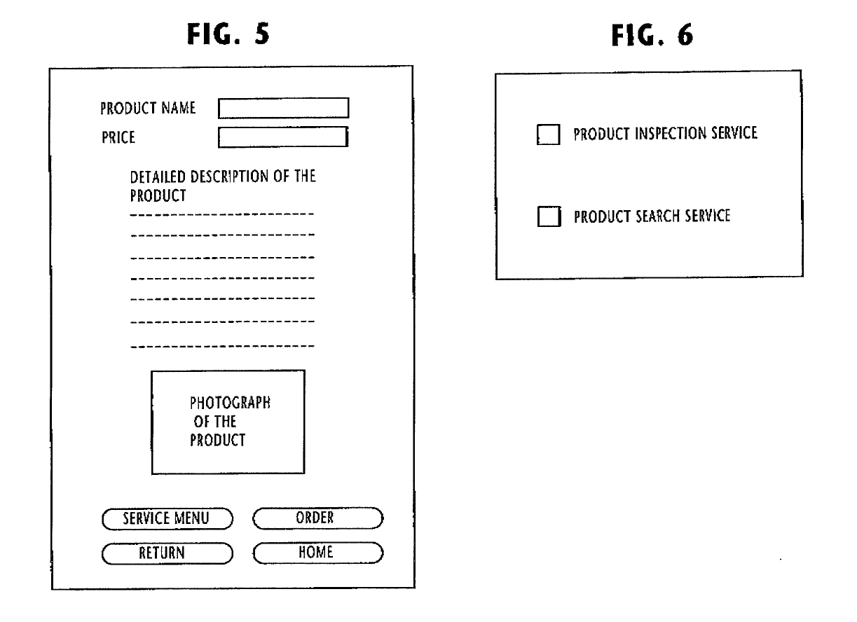

FIG. 5 is an illustration of a window displayed when a details button is clicked in the window of FIG. 4;

FIG. 6 is an illustration of a window displayed when a service menu button is clicked in the window of FIG. 5;

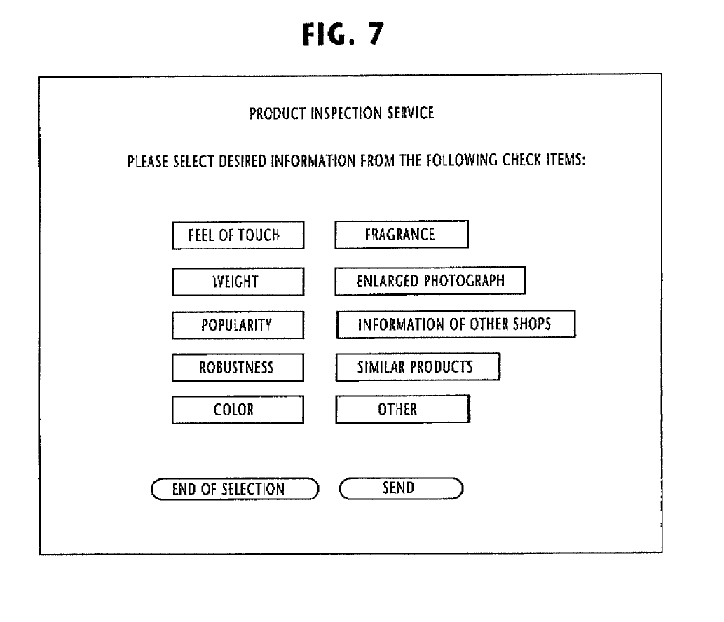

FIG. 7 is an illustration of a window displayed when the product inspection button is clicked in the window of FIG. 6;

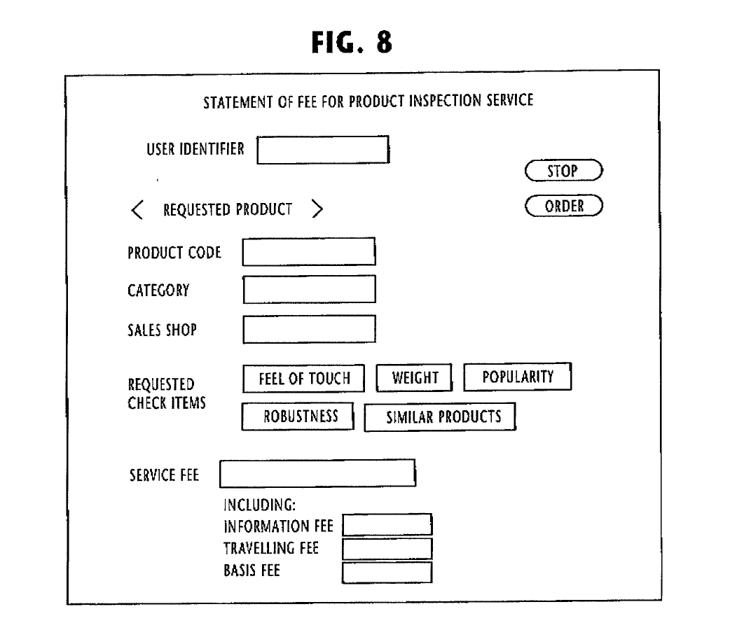

FIG. 8 is an illustration of a window displayed when the user terminal receives a statement of service fee; and

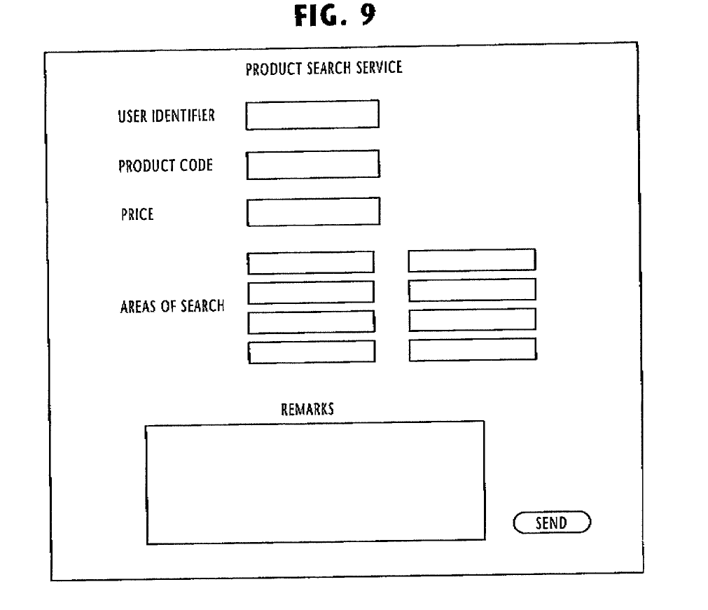

FIG. 9 is an illustration of a window displayed when the product search button is clicked in the window of FIG. 6.

### DETAILED DESCRIPTION

Referring to FIG. 1, there is shown an ordering system for assisting registered customers to facilitate purchasing sales items that are only available in shops not corrected to the communications network. The system includes a plurality of user terminals 10 or desktop/notebook computers connected to a communications network 11 such as the Internet. Via the network 11, the user terminals 10 access an agent server 12 which provides assistance service to the user terminals 10 for placing a purchase order to sales shops 13 that are not connected to the network 11. When a sales item desired by a user is not available from the network but one of the sales shops 13, the user may wish to place an order to the agent server 12 for purchasing the desired item on behalf of the user.

Agent server 12 includes a number of databases 21, 22 and 23. Database 21 is a sales menu memory in which sales items available in the sales shops 13 are classified into a number of different categories and information describing details of each sales item is stored as a sales menu. Database 22 is a service menu memory in which information necessary for making a product inspection and a product search are stored as a service menu. Database 23 is a cost memory in which cost data such as travelling costs necessary for calculating service fees are stored. To the memories 21, 22, 23 are connected a display unit 24 and a control unit 25 which reads information from one of the memories and transmits it to a user terminal through a link established by a line interface 20 in the communications network 11.

In FIGS. 2 and 3, the operation of the system begins with a user terminal 10 accessing the agent server 12 through the network 11 and opening the web-site home page of the agent server. User terminal 10 sends a packet to the agent server, containing a user identifier and a password (step A1, FIG. 2). In response to the packet from the user terminal, the agent server 12 checks the password to verify the user identifier. If the user identifier is verified, the server reads data from the memories 21 and 22 and sends sales information containing a product menu (catalogue) and a service menu to the user terminal (step B1, FIG. 3). User terminal 10 stores the transmitted data and displays a list of product categories (step A2). When the user selects one of the product categories, a sales menu of the selected category is put on display (step A3).

As shown in FIG. 4, the sales menu is divided into a plurality of entries for respective sales items. Each product entry is divided into a plurality of fields for indicating a product code, the product name, a brief description of the product the price, the name of a shop where the product is available, a railway station nearest to the shop, and a button for further information of the product. Product categories other than the selected one are also displayed in the menu to allow the user to select a further sales menu.

If the user wishes to buy one of the products indicated in the product entries, he clicks the “details button” of the corresponding product entry. In response, the user terminal displays details of the selected product (step A4). As shown in FIG. 5, the displayed details of the product include the product name, price, size, weight and suggested uses, and buttons for “service menu”, “purchase order”, “previous window” and “home page”. The user is prompted to click one of these buttons. If the user is satisfied with the selected product and clicks the “purchase order” button (step A5), the user (step A5), the user terminal sends a purchase order of the selected product to the agent server (step A16).

After sending the product and service menus to a user terminal, the agent server 12 is monitoring a signal from the user terminal, and when one is received, examines the information it contains (step B2). If the received signal is a purchase order, flow branches to step B3 to store the customer's name and acknowledges receipt of the purchase order by sending an acknowledge message to the user terminal. The agent personnel at the server makes a purchase of the ordered product from one of the sales shops 13 on behalf of the customer and dispatches the purchased item to the user terminal.

If the user is not satisfied with the information being displayed in the “product details”, the “service menu” button may be clicked (step A5). In this case, the user terminal displays a window containing a “product inspection service” button and a “product search service” button as shown in FIG. 6 to allow the user to choose one of the two services (step A6).

The “product inspection service” button is used when the user requests the agent to make a trip in lieu of the user to the sales shop where the desired product is available and inspect it in detail in respect of the user' requested items and send an inspection report to the user. The product search service is one which will be selected if the user finds no satisfied product in the displayed information. In this case, the user requests the agent to conduct a search through a number of requested shopping areas for a desired product and send a search report to the user.

If the “product inspection service” button is clicked (step A7), flow proceeds to step A8 to display a window illustrating a plurality of check items which the agent is requested to inspect the sales product.

As shown in FIG. 7, the check items of the product include “feel of touch”, “weight”, “reputation/popularity”, “robustness”, “color”, “fragrance”, “enlarged photograph”, “information of other shops”, “similar products”, and “others”. Each of these check items may include a sub-menu for displaying a number of sub-items when the user clicks one of the check items for specifying further check items. The displayed window further displays an “end of selection” button and a “proceed to send” button. For example, the “enlarged photograph” item may include a sub-item indicating the number of such photographs taken at different angles. When a number of desired check items have been selected, the user clicks the “end of selection” button and then the “proceed to send” button. When the user clicks the “proceed to send” button (step A9), the user terminal formulates a request packet with the window data and sends it to the agent server for enquiry of a service fee of the product inspection (step A10).

In FIG. 3, when the agent server receives the request packet (step B2), the control unit 25 proceeds to step B4 to examine the check items requested by the user and calculate the service fee for the requested product inspection by using cost data stored in the cost memory 23. Control unit 25 prepares a statement of service fee, as shown in FIG. 8, and sends the statement to the user terminal and returns to step B2 to wait for the next signal from the user.

In FIG. 2, the user terminal receives the statement of service fee from the agent server and opens a window for displaying the contents of the received statement along with an Order button and a Stop button (step A11).

User terminal 10 proceeds to decision step A12 to determine which of the window buttons is clicked. If the user is not satisfied with the service fee, the Stop button is clicked and in response flow proceeds to the end of the routine. If the user is satisfied with the service fee, the Order button is clicked and the user terminal proceeds to step A13 and sends a product inspection order to the server 12. The product inspection order includes the user identifier, the product category, the product code, the check items and the service fee.

In FIG. 3, the agent server, which is monitoring the line interface 20 at step B2, receives the product inspection order from the user terminal and branches out to step B5. The agent server opens a window to display the received inspection order and assigns a unique application number to the requested product (step B6) and sends an acknowledgment message by an e-mail to the user terminal, containing the assigned application number (step B7).

Then, the personnel at the agent server 12 makes a trip to a sales shop where the requested product is available and manually inspects it in respect of the requested check items and requests the sales shop to reserve the product for possible purchase. The agent prepares an inspection report with photographs if requested. The agent may recalculate the service fee if necessary. Agent server 12 transmits the inspection report to the user terminal at step B8 with a bill for charging the amount of service fee which was calculated at step B4 or recalculated. Control unit 25, and returns to step B2 for monitoring the line interface 20 to detect a signal from the user terminal.

Returning to FIG. 2, the user terminal receives the inspection report at step A14 and displays it in a window to allow the user to click one of Order and Stop buttons. If the user is satisfied with the report of the product inspection service, the Order button is clicked (step A15) and a purchase order is sent to the agent server (step A16). The transmitted purchase order includes the user's identifier, the password, and the application number. If the Stop button is clicked, flow proceeds from step A15 to the end of the routine.

When the agent server 12 receives the transmitted purchase order, the control unit 25 proceeds from step B2 to step B3 to acknowledge the purchase order and purchase the ordered product from the sales shop and requests the sales shop to transport the sales item to the user's location along with a bill for charging the product price and the shipment or handling cost.

If no desired sales product is found in the sales menu, the user may wish to select the product search service by clicking the associated button in the window of FIG. 6 (step A7). In this case, flow proceeds to step A17 to open a window as shown in FIG. 9, in which the user is urged to enter information necessary for the agent to perform a search for the desired sales product. The displayed window shows a number of blank spaces in which the user is requested to enter the names of shopping areas, the product name, product category.

When the user has entered necessary information and clicks a “SEND” button in the displayed window (step A18), the user terminal formulates a request packet with the entered data and sends the request packet to the agent server for enquiry of a service fee of the product search (step A19).

When this request packet is received, the agent server proceeds from step B2 to step B9. Using the area information contained in the request packet and data stored in the cost memory 23, the agent server calculates the service fee. The personnel at the agent server makes a trip around all the shopping areas specified in the request packet in search of the target product and prepares a search report. Agent server 12 sends this search report to the user terminal and returns from step B9 to step B2.

When the user terminal receives the statement of service fee (step A20), it opens a window for displaying the contents of the received statement along with an Order button and a Stop button (step A20). Flow proceeds to decision step M1 to determine which of the window buttons is clicked. If the user is not satisfied with the service fee, the Stop button is clicked to terminate the routine. If the user is satisfied with the service fee, the Order button is clicked and flow proceeds to step A22, where the user terminal formulates a packet with the window data and sends it to the server 12 as a product search order.

In response to the product search order, the agent server proceeds to step B10 and opens a window to display the received search order and assigns a unique application number to the requested product (step B11) and sends an e-mail to the user terminal to acknowledge the receipt of the order, containing the assigned application number (step B12). The agent prepares a search report detailing the results of the product search and recalculates the service fee to reflect the actual cost of the search, if necessary. If the requested product is found, the search report includes photographs of the product, the sales shop where it is found, the nearest railway station to the shop, the product price and the application number. At step B13, the agent server sends the search report to the user terminal with a bill for charging the service fee which was calculated at step B9 or recalculated, and returns to step B2.

At step A14, the user terminal receives the search report and opens a window to display its contents, allowing the user to click one of Order and Stop buttons. If the search report indicates that the requested product is not found in any of the specified shopping areas, the user clicks the Stop button to terminate the routine. If the user is satisfied with the search report, the Order button is clicked (step A15) and a purchase order is sent to the agent server (step A16). The transmitted purchase order includes the user's identifier, the password, and the application number.

When the agent server receives the transmitted purchase order, the control unit 25 proceeds from step B2 to step B3 to acknowledge the purchase order and purchase the ordered item from the sales shop and requests the sales shop to transport the sales item to the user's location along with a bill for charging the product price and the shipment or handling cost.

What is claimed is:

1. An ordering method comprising:
transmitting sales information from an agent server to a user terminal a via a communications network;
displaying the transmitted sales information at said user terminal to allow a user to select an item, and transmitting a purchase order of the selected item from the user terminal to the agent server for requesting a purchase of said selected item on behalf of said user, said sales information containing items that are only available in sales shops which are not accessible via said communications network; and
at said agent server, transmitting an acknowledgment message to said user terminal in response to said purchase order.

2. An ordering method comprising:
transmitting sales information from an agent server to a user terminal via a communications network;
at said user terminal, displaying the transmitted sales information to allow a user to select an item and transmitting a request signal to said server for a service charge required for inspecting the selected item;
at said agent server, determining said service charge depending on contents of the request signal and a cost database, and transmitting the determined service charge to said user terminal;
at said user terminal, displaying the transmitted service charge to allow said user to make a decision as to whether an inspection of said selected item is performed and transmitting a request signal to said server for indicating that the selected item be inspected when said user makes said decision;
at said agent server, transmitting an inspection report of said item to said user terminal;
at said user terminal, displaying the transmitted inspection report to allow said user to make a decision as to whether said item is purchased and transmitting a purchase order to said agent server for requesting a purchase of said selected item on behalf of said user when the user makes the decision; and
at said agent server, transmitting an acknowledgment message to said user terminal in response to said purchase order.

3. The ordering method of claim 2, wherein said sales information contains items that are only available in sales shops which are not accessible via said communications network.

4. The ordering method of claim 2, wherein said inspection report contains a bill for requesting the user to pay for said inspection of the selected item.

5. An ordering method comprising:
transmitting sales information from an agent server to a user terminal via a communications network;
at said user terminal, displaying the transmitted sales information to allow a user to select an item and transmitting a request signal to said server for a service charge required for making a search for a desired item if the desired item is not found in the displayed information;
at said agent server, determining said service charge depending on contents of the request signal and a cost database, and transmitting the determined service charge to said user terminal;
at said user terminal, displaying the transmitted service charge to allow said user to make a decision as to whether said search is performed and transmitting a request signal to said server for indicating that the desired item be searched when said user makes said decision;
at said agent server, transmitting a search report of said item to said user terminal;
at said user terminal, displaying the transmitted search report to allow said user to make a decision as to whether said item is purchased and transmitting a purchase order to said agent server for requesting a purchase of said item on behalf of said user when the user makes the decision; and
at said agent server, transmitting an acknowledgment message to said user terminal in response to said purchase order.

6. The ordering method of claim 5, said sales information contains items that are only available in sales shops which are not accessible via said communications network.

7. The ordering method of claim 5, wherein said search report contains a bill for requesting the user to pay for said search of the selected item.

8. An ordering method comprising the steps of:
a) transmitting sales information from an agent server to a user terminal via a communications network;
b) at said user terminal, displaying the transmitted sales information to allow a user to select one of a plurality of decision branches;
c) transmitting to said agent server a purchase order if the user selects a first decision branch, a first request signal for requesting a first service charge required for inspecting a desired item contained in said displayed information if the user selects a second decision branch, and a second request signal for requesting a second service charge required for making a search of a desired item which is not contained in said displayed information if the user selects a third decision branch;
d) at said agent server, determining said first service charge if said first request signal is received depending on contents of the first request signal and a cost database, determining said second service charge if said second request signal is received depending on contents of the second request signal and a cost database, and transmitting the determined first or second service charge to said user terminal;
e) at said user terminal, displaying the transmitted service charge to allow said user to make a decision as to whether an inspection or a search of the desired item is performed and transmitting a request signal to said server for indicating that the desired item be inspected or searched when said user makes said decision;
f) at said agent server, transmitting an inspection report of said item or a search report of said item to said user terminal, depending on contents of the request signal of step (e);
g) at said user terminal, displaying the transmitted inspection report or search report to allow said user to make a decision as to whether said item is purchased and transmitting a purchase order to said agent server for requesting a purchase of said item on behalf of said user if the user makes the decision; and
h) at said agent server, transmitting an acknowledgment message to said user terminal if the purchase order of step (c) or step (g) is received.

9. The ordering method of claim 8, wherein said sales information contains items that are only available in sales shops which are not accessible via said communications network.

10. The ordering method of claim 8, wherein said inspection report contains a bill for requesting the user to pay for said inspection of the selected item and said and said search report contains a bill for requesting the user to pay for said search of the selected item.

11. An ordering system comprising:
a communications network;
a plurality of user terminals connected to said network;
an agent server connected to said network for transmitting sales information to a user terminal of one of said plurality of user terminals;
the user terminal displaying the transmitted sales information to allow a user to select an item, and transmitting a purchase order of the selected item to the agent server for requesting a purchase of said selected item on behalf of said user, said sales information containing items that are only available in sales shops which are not accessible via said communications network; and
said agent server transmitting an acknowledgment message to said user terminal in response to said purchase order.

12. An ordering system comprising:
a communications network;
a plurality of user terminals connected to said network;
an agent server connected to said network for transmitting sales information to a user terminal of one of said plurality of user terminals;
the user terminal displaying the transmitted sales information to allow a user to select an item and transmitting a request signal to said server for a service charge required for inspecting the selected item;
said agent server determining said service charge depending on contents of the request signal and a cost database, and transmitting the determined service charge to said user terminal;
said user terminal displaying the transmitted service charge to allow said user to make a decision as to whether an inspection of said selected item is performed and transmitting a request signal to said server for indicating that the selected item be inspected when said user makes said decision;
said agent server transmitting an inspection report of said item to said user terminal;
said user terminal displaying the transmitted inspection report to allow said user to make a decision as to whether said item is purchased and transmitting a purchase order to said agent server for requesting a purchase of said selected item on behalf of said user when the user makes the decision; and
said agent server transmitting an acknowledgment message to said user terminal in response to said purchase order.

13. The ordering system of claim 12, wherein said sales information contains items that are only available in sales shops which are not accessible via said communications network.

14. The ordering system of claim 12, wherein said inspection report contains a bill for requesting the user to pay for said inspection of the selected item.

15. An ordering system comprising:
a communications network;
a plurality of user terminals connected to said network;
an agent server connected to said network for transmitting sales information to a user terminal of one of said plurality of user terminals;
the user terminal displaying the transmitted sales information to allow a user to select a desired item and transmitting a request signal to said server for a service charge required for making a search of the desired item if the desired item is not found in the displayed information;
said agent server determining said service charge depending on contents of the request signal and a cost database, and transmitting the determined service charge to said user terminal;
said user terminal displaying the transmitted service charge to allow said user to make a decision as to whether said search is performed and transmitting a request signal to said server for indicating that the desired item be searched when said user makes said decision;
said agent server transmitting a search report of said item to said user terminal;
said user terminal displaying the transmitted search report to allow said user to make a decision as to whether said desired item is purchased and transmitting a purchase order to said agent server for requesting a purchase of said desired item on behalf of said user when the user makes the decision, and
said agent server transmitting an acknowledgment message to said user terminal in response to said purchase order.

16. The ordering system of claim 15, wherein said sales information contains items that are only available in sales shops which are not accessible via said communications network.

17. The ordering system of claim 15, wherein said search report contains a bill for requesting the user to pay for said search of the selected item.

18. An ordering system comprising:
a communications network;
a plurality of user terminals connected to said network;
an agent server connected to said network for transmitting sales information to a user terminal of one of said plurality of user terminals;
said user terminal displaying the transmitted sales information to allow a user to select one of a plurality of decision branches, transmitting to said agent server a first purchase order if the user selects a first decision branch, a first request signal for requesting a first service charge required for inspecting a desired item contained in said displayed information if the user selects a second decision branch, and a second request signal for requesting a second service charge required for making a search of a desired item which is not contained in said displayed information if the user selects a third decision branch,
said agent server determining said first service charge if said first request signal is received depending on contents of the first request signal and a cost database, determining said second service charge if said second request signal is received depending on contents of the second request signal and a cost database, and transmitting the determined first or second service charge to said user terminal;
said user terminal displaying the transmitted service charge to allow said user to make a decision as to whether an inspection or a search of the desired item is performed and transmitting a request signal to said server for indicating that the desired item be inspected or searched when said user makes said decision;
said agent server transmitting an inspection report of said item or a search report of said item to said user terminal, depending on contents of the request signal,
said user terminal displaying the transmitted inspection report or search report to allow said user to make a decision as to whether said item is purchased and transmitting a second purchase order to said agent server for requesting a purchase of said item on behalf of said user if the user makes the decision, and
said agent server transmitting an acknowledgment message to said user terminal in response to each of said first and second purchase orders.

19. The ordering system of claim 18, wherein said sales information contains items that are only available in sales shops which are not accessible via said communications network.

20. The ordering system of claim 18, wherein said inspection report contains a bill for requesting the user to pay for said inspection of the selected item and said and said search report contains a bill for requesting the user to pay for said search of the selected item.
